(19) United States
(12) Patent Application Publication
(10) Pub. No.: US 2014/0037336 A1
(43) Pub. Date: Feb. 6, 2014

(54) PHOTOSENSITIVE DRUM AND A PROCESS CARTRIDGE

(71) Applicant: Mei Yan, Jiangxi (CN)

(72) Inventor: Mei Yan, Jiangxi (CN)

(73) Assignee: Jiangxi YiBo E-TECH Co., Ltd., Jiangxi (CN)

(21) Appl. No.: 13/809,202

(22) PCT Filed: Sep. 15, 2011
(86) PCT No.: PCT/CN11/01564

§ 371 Date: Jan. 9, 2013

(30) Foreign Application Priority Data
Jul. 13, 2011 (CN) 201120255926.7

(51) Int. Cl. G03G 15/00

(52) U.S. Cl. CPC G03G 21/1647; G03G 21/1671
USPC 399/167

(57) ABSTRACT

A photosensitive drum includes a cylindrical photoreceptor, a drum gear located at one end of the photoreceptor, a drum shaft extending axially along the photoreceptor from one end of the drum gear for rotatably supporting the photoreceptor, and a projecting member extending longitudinally along the photoreceptor from an end surface of the drum shaft for coupling a twisted surface of a corresponding twisted triangular groove on a driving head of an imaging device. The projecting member, which is provided at one end of the photoreceptor, is operable to reciprocate along the longitudinal direction of the photoreceptor with respect to the photoreceptor. As a result, the photosensitive drum is prevented from being ejected from the driving head of the imaging device during force transmission between them, while maintaining a stable transmission of driving force between the photosensitive drum and the imaging device. A process cartridge carries the photosensitive drum.

### FIELD OF THE INVENTION

The invention relates to a photosensitive drum used in an imaging device and a process cartridge provided with the photosensitive drum.

### BACKGROUND OF THE INVENTION

A process cartridge for an imaging device can be detachably installed within the main body of the imaging device and, as a whole unit, comprises an electrophotographic photosensitive assembly and at least one processing means such as charging means, developing means, cleaning means, or the like. The cartridge is detachably installed within the main body of the imaging device for convenience of maintenance. An electrophotographic imaging device functions in the following manner: an electrostatic latent image is formed by selectively exposing the electrophotographic photosensitive assembly which is uniformly charged by a charger under light from the imaging device; the electrostatic latent image is developed with a developing means using a toner into a toner image; the toner image thus formed is transferred onto a recording medium by a transferring means to form an image on a recording material.

FIG. 1 is a perspective view of a driving head of an imaging device being separated from a driving head of a photosensitive drum in the prior art. The figure illustrates force transmission between a driving head 17 of a conventional photosensitive drum in a process cartridge and a driving head 18 of the imaging device. One end of the driving head 18 of the imaging device is provided with a twisted triangular groove 18a and one end of the driving head 17 of the photosensitive drum is correspondingly provided with a non-twisted triangular projecting member 17a, wherein the non-twisted triangular projecting member 17a and the twisted triangular groove 18a match with each other for transmission of driving force. This connection structure has a disadvantage that the non-twisted triangular projecting member 17a is prone to be ejected from the twisted triangular groove 18a. This can seriously influence the transmission efficiency between the driving head 17 of the photosensitive drum and the driving head 18 of the imaging device.

Thus, in configuration or use, conventional photosensitive drums and process cartridges still have disadvantages or defects and need to be further developed. To solve this problem, each concerned manufacturer tries to find a better solution. However, they have so far not succeeded in designing an improved device with appropriate configuration. Obviously, a skilled person may be anxious to approach to the solutions. Therefore, how to obtain a photosensitive drum with new structure, as well as a process cartridge, is indeed one of the most important studies recently, also an object in current industry.

### SUMMARY OF THE INVENTION

An object of the present invention is to overcome defects in the existing photosensitive drums and process cartridges and provide a photosensitive drum and a process cartridge with improved configurations. A technical problem to be solved is how to provide a projecting member, which may be operable to reciprocate along a longitudinal direction of a photoreceptor, on an end surface of a shaft of a photosensitive drum, so that a driving head of the photosensitive drum can properly match with a driving head of an imaging device, thereby effectively solving the problem that the driving head of the photosensitive drum is prone to be ejected from a twisted triangular groove in the imaging device.

In order to achieve the above-mentioned object of the invention and solve the technical problem, the invention provides a technical solution as will be illustrated below.

The invention provides a photosensitive drum, comprising a cylindrical photoreceptor, a drum gear located at one end of the photoreceptor, a drum shaft extending along an axial direction of the photoreceptor from one end of the drum gear for rotatablely supporting the photoreceptor, and a projecting member extending along a longitudinal direction of the photoreceptor from an end surface of the drum shaft for coupling a twisted surface of a corresponding twisted triangular groove on a driving head of an imaging device, wherein the projecting member, which may be provided at the end of the photoreceptor, may be operable to reciprocate along the longitudinal direction of the photoreceptor with respect to the photoreceptor.

The object of the invention and the technical problem can also be achieved by the following technical solutions.

There is provided said photosensitive drum and said process cartridge, wherein an open groove may be arranged on the end surface of the drum shaft corresponding to the projecting member, and the projecting member, which may be provided within the open groove, may be operable to reciprocate along the longitudinal direction of the photoreceptor with respect to the photoreceptor.

There is provided said photosensitive drum and said process cartridge, wherein the drum shaft may be fixedly arranged on a boss on the end of the drum gear and a holding space may be formed between an end surface of the boss and the drum shaft; the open groove arranged on the end surface of the drum shaft, may extend through the end surface of the drum shaft so as to connect the holding space with the exterior of the drum shaft, the projecting member located within the open groove may have one end extending into the holding space and the other end projecting from the end surface of the drum shaft, the portion of the projecting member located within the holding space may be provided with a position limiter projecting from a side wall of the projecting member and abutting the circumference of the corresponding open groove on the drum shaft, and an elastic member may be arranged between the projecting member and the end surface of the boss of the drum gear.

There is provided said photosensitive drum and said process cartridge, wherein the elastic member may be a compression spring, which is located in the holding space and sleeves a guide column of the projecting member, and the compression spring may have one end abutting the end surface of the boss of the drum gear and the other end abutting the position limiter of the projecting member.

There is provided said photosensitive drum and said process cartridge, wherein the projecting member may be fixedly arranged on the end surface of the drum shaft, the drum shaft, which may be arranged at the end of the drum gear, may be operable to reciprocate along the axial direction of the photoreceptor, and an elastic member may be arranged between the drum shaft and the drum gear.

There is provided said photosensitive drum and said process cartridge, wherein a force transmitting unit and a guide column may be mounted at the end of the drum shaft corresponding to the drum gear, and a force receiving unit for matching the force transmitting unit and a guide groove for holding the guide column may be correspondingly mounted on the drum gear.

There is provided said photosensitive drum and said process cartridge, wherein the force transmitting unit may include two arc-shaped bosses symmetrically provided on the outer peripheral surface of the end of the drum shaft corresponding to the drum gear, and the arc-shaped bosses may form two symmetrical notched grooves on the outer peripheral surface of the drum shaft, wherein the guide column may extend from the end of the drum shaft corresponding to the drum gear, the force receiving unit may include two arc-shaped protrusions, which are symmetrically provided on the inner wall of a holding groove for matching the symmetrical notched grooves, wherein the holding groove for holding the drum shaft may be arranged at the end of the drum gear corresponding to the drum shaft, and the guide groove may be arranged at one end of the holding groove and extend into the drum gear.

There is provided said photosensitive drum and said process cartridge, wherein the elastic member may be a compression spring, which is located in the guide groove and sleeves the guide column, and the compression spring may have one end abutting a drum shaft positioning surface formed at a joint of the guide column and the drum shaft and the other end abutting a drum gear positioning surface formed at the other end of the drum gear by the guide groove.

There is provided said photosensitive drum and said process cartridge, further comprising a drum shaft axial positioning element, which may be lodged in an axial positioning groove on a positioning column of the drum shaft, wherein the positioning column may run through the positioning groove of the drum gear and extend from the other end of the drum gear, and the axial positioning groove may be arranged on the positioning column extending from the other end of the drum gear.

There is provided said photosensitive drum and said process cartridge, wherein the projecting member may be fixedly arranged on the end surface of the drum shaft, the drum shaft may be fixedly arranged at the end of the drum gear, the drum gear, which may be arranged at the end of the photoreceptor, may be operable to reciprocate along the axial direction of the photoreceptor, and an elastic member may be arranged between the drum gear and the photoreceptor.

There is provided said photosensitive drum and said process cartridge, wherein a force transmitting unit and a guide column may be mounted at the end of the drum gear corresponding to the photoreceptor, and a force receiving unit for matching the force transmitting unit and a guide groove for holding the guide column may be correspondingly mounted on the photoreceptor.

There is provided said photosensitive drum and said process cartridge, wherein the force transmitting unit may include two arc-shaped protrusions, which are symmetrically provided on the end of the drum gear corresponding to the photoreceptor and extending from the outer peripheral edge of the end surface thereof towards the photoreceptor; the guild column may extend from the center of the end of the drum gear corresponding to the photoreceptor; the guide groove may be arranged at the end of the photoreceptor corresponding to the drum gear; the force receiving unit may include two arc-shaped recesses, which are symmetrically arranged on the inner wall of the guide groove and extending along the axial direction of the photoreceptor from the open end of the guide groove, corresponding to the drum gear, to the bottom surface of the guide groove for matching the arc-shaped protrusions of the drum gear, wherein a gear portion of the drum gear may always be located outside the guide groove.

There is provided said photosensitive drum and said process cartridge, wherein the elastic member may be a compression spring, which may be located in the guide groove and sleeve the guide column, wherein the compression spring may have one end abutting a drum gear positioning surface formed at a joint of the guide column and the drum gear and the other end abutting the bottom surface of the guide groove.

There is provided said photosensitive drum and said process cartridge, further comprising a drum gear axial positioning element, which may be lodged in an axial positioning groove on a positioning column of the drum gear, wherein the positioning column may extend through the bottom surface of the guide groove of the photoreceptor and project therefrom, and the axial positioning groove may be arranged on the positioning column extending from the bottom surface of the guide groove of the photoreceptor.

There is provided said photosensitive drum and said process cartridge, wherein the projecting member may include three vertical projecting members extending along the longitudinal direction of the photoreceptor from the end surface of the drum shaft, and these vertical projecting members may respectively correspond to three twisted surfaces of a twisted triangular groove on the driving head of the imaging device.

There is provided said photosensitive drum and said process cartridge, wherein the projecting member may include two vertical projecting members extending along the longitudinal direction of the photoreceptor from the end surface of the drum shaft, and these vertical projecting members may respectively correspond to two twisted surfaces of a twisted triangular groove on the driving head of the imaging device.

There is provided said photosensitive drum and said process cartridge, wherein a guide slanting surface may be arranged on an end surface of each projecting member located on the end surface of the drum shaft, and the guide surfaces may be arranged on a side wall of each projecting member for coupling the corresponding twisted surfaces.

There is provided said photosensitive drum and said process cartridge, wherein a boss may be arranged between the vertical projecting members on the end surface of the drum shaft, and the vertical projecting members may be provided on a side wall of the boss.

The object of the invention and the technical problem can also be achieved by the following technical solutions.

Specifically, the invention provides a process cartridge, comprising the aforementioned photosensitive drum.

According to the above-mentioned technical solutions, the photosensitive drum and the process cartridge according to the present invention are advantageous at least in that, by providing a projecting member, which is operable to reciprocate along the longitudinal direction of a photoreceptor, on one end surface of the shaft of the photosensitive drum, the projecting member of the photosensitive drum may be subjected to a force applied by an elastic member arranged at the end of the projecting member during driving force transmission between the imaging device and the photosensitive drum, so that the photosensitive drum can keep coupling the driving head of the imaging device, but not be ejected therefrom. This will effectively lead to a normal transmission of driving force. The problem that the driving head of the photosensitive drum is prone to be ejected from the imaging device can therefore be solved.

As discussed above, the invention relates to a photosensitive drum and a process cartridge.

The photosensitive drum comprises a photoreceptor, a drum gear located at one end of the photoreceptor, a drum shaft extending along an axial direction of the photoreceptor from one end of the drum gear for rotatablely supporting the photoreceptor, and a projecting member extending along a longitudinal direction of the photoreceptor from an end surface of the drum shaft for coupling a twisted surface of a corresponding twisted triangular groove on a driving head of an imaging device, wherein the projecting member, which may be provided at one end of the photoreceptor, may be operable to reciprocate along the longitudinal direction of the photoreceptor with respect to the photoreceptor. As a result, it can ensure that the photosensitive drum according to the invention will not be ejected from the driving head of the imaging device during force transmission between them, but effectively guarantee a stable transmission of driving force between the photosensitive drum and the imaging device. The invention further provides a process cartridge adopting the photosensitive drum.

The above section is only an overview of the technical solutions of the invention. In order to allow the technical means of the invention to be better understood, specific embodiments are described below. Further objects, characteristics and advantages of the invention will become clearer from the following description of preferred embodiments as well as from the drawing.

### BRIEF DESCRIPTION OF THE DRAWINGS

FIG. 1 is a perspective view of a driving head of an imaging device being separated from a driving head of a photosensitive drum in the prior art;

FIG. 2 is a perspective view of a driving head of a photosensitive drum according to a first embodiment of the present invention;

FIG. 3 is a perspective view of a driving head separated from one end of a photoreceptor according to the first embodiment of the present invention;

FIG. 4 is a section view of the driving head at the end of the photoreceptor according to the first embodiment of the present invention;

FIG. 5 is a schematic diagram showing the coupling between the driving head of the photosensitive drum and the driving head of the imaging device according to the first embodiment of the present invention;

FIG. 6 is a schematic diagram showing the coupling between a driving head of a photosensitive drum and a driving head of a imaging device according to a second embodiment of the present invention;

FIG. 7 is a perspective view of a driving head of a photosensitive drum according to a third embodiment of the present invention;

FIG. 8 is a perspective view of a driving head at one end of a photoreceptor according to the third embodiment of the present invention;

FIG. 9 is a section view of setting a projecting member at the end of the photosensitive drum according to the third embodiment of the present invention;

FIG. 10 is a section view of a driving head of a photosensitive drum according to a fourth embodiment of the present invention;

FIG. 11 is a perspective view of a driving head of a photosensitive drum according to a fifth embodiment of the present invention;

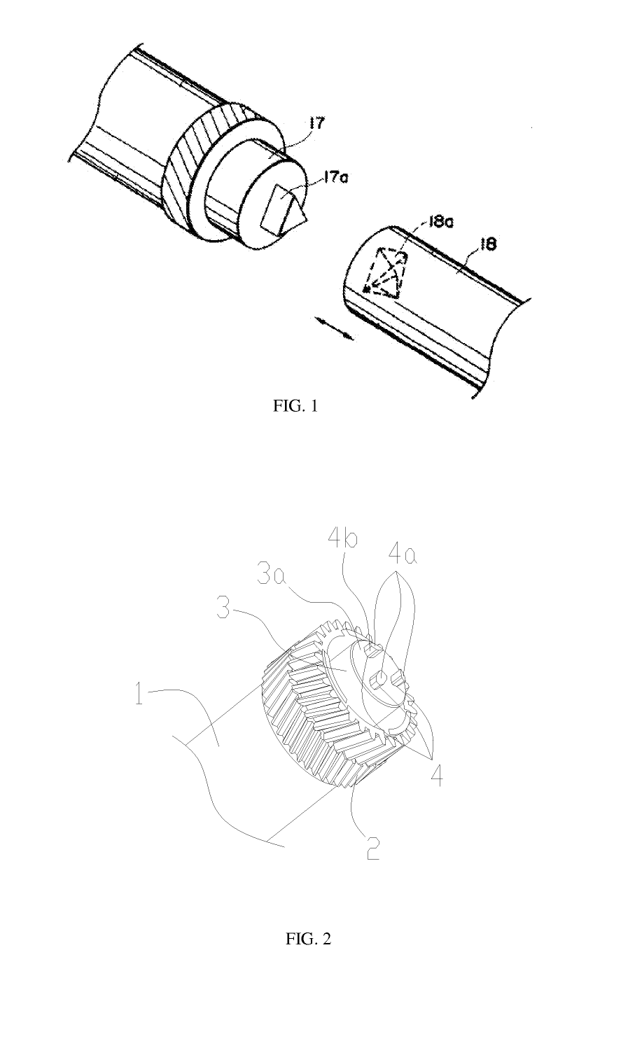

| | |
|---|---|
| 1: photoreceptor | 1a: guide groove |
| 1a1: open end | 1a2: bottom surface |
| 1b: force receiving unit | 2: drum gear |
| 2a: force receiving unit | 2a1: holding groove |
| 2b, 2e: drum gear positioning surface | 2c: guide groove |
| 2d: end surface | 2f: guide column |
| 2g: force transmitting unit | 2i: axial positioning column |
| 2h: gear unit | 3: drum shaft |
| 3a: end surface | 3b: force transmitting unit |
| 3b1: notched groove | 3c: guide column |
| 3d: axial positioning groove | 3e: drum shaft positioning surface |
| 3f: open groove | 4: projecting member |
| 4a: guide slanting surface | 4b: guide surface |
| 4c: position limiter | 4d: guide column |
| 5: boss | 5a: guide column |
| 5b: positioning surface | 6, 6a, 6b, 6c: elastic member |
| 7: drum shaft axial positioning | 7a: drum gear axial positioning |
| element | element |
| 11: twisted groove | 12: twisted surface |
| 13: elastic member | 17: driving head |
| 17a: non-twisted projecting member | 18: driving head |
| 18a: twisted groove | 20: driving head |
| L: longitudinal direction | |

### DESCRIPTION OF THE PREFERRED EMBODIMENTS

In order to further describe the technical means adopted to achieving the object of the invention and the effects thereof, the details, structure, characteristics, technical process and effects of the method and the system for user identity recognition based on specific information provided by the invention will be described in detail below. It should be understood that the specific embodiments described below only serve to illustrate the present invention, but are not meant to limit the scope of the present invention.

The invention provides a photosensitive drum provided in a process cartridge, comprising a cylindrical photoreceptor 1, a drum gear 2 located at one end of the photoreceptor 1, a drum shaft 3 extending along an axial direction of the photoreceptor 1 from one end of the drum gear 2 for rotatablely supporting the photoreceptor 1 during the working process of the process cartridge, and a projecting member 4 extending along a longitudinal direction L of the photoreceptor 1 from an end surface 3a of the drum shaft 3 for coupling a twisted surface 12 of a corresponding twisted triangular groove 11 on a driving head 20 of an imaging device, wherein the projecting member 4, which is provided at one end of the photoreceptor 1, is operable to reciprocate along the longitudinal direction L of the photoreceptor 1 with respect to the photoreceptor 1.

### Embodiment 1

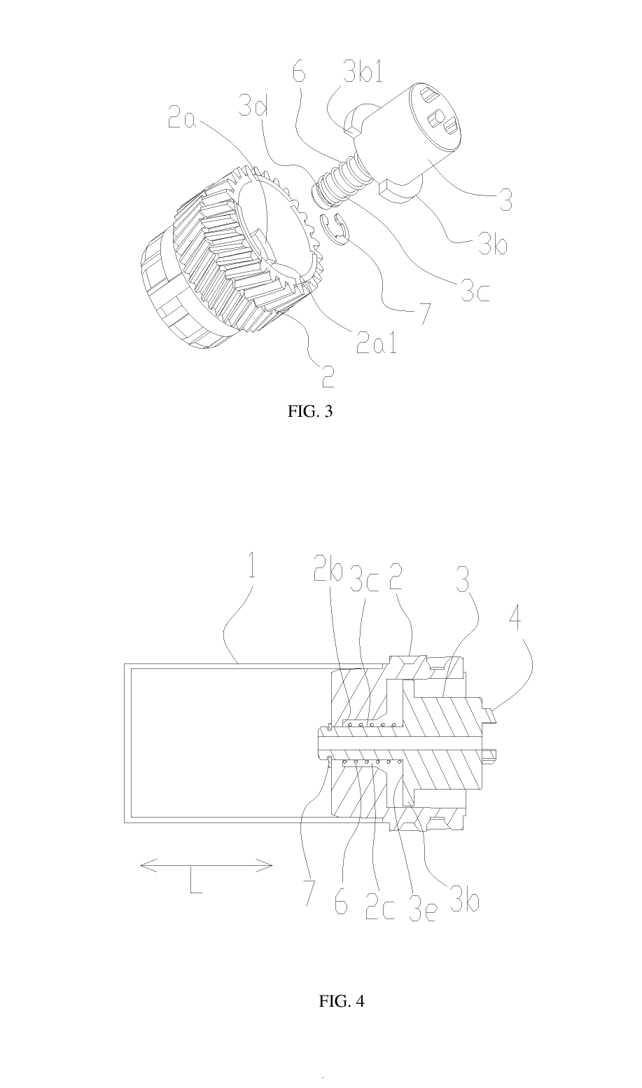

FIG. 2 is a perspective view of a driving head of a photosensitive drum according to a first embodiment of the present invention, FIG. 3 is a perspective view of a driving head separated from one end of a photoreceptor according to the first embodiment of the present invention, and FIG. 4 is a section view of the driving head at the end of the photoreceptor according to the first embodiment of the present invention. In the embodiment, as shown in FIG. 2 to FIG. 4, the projecting member 4 is fixedly arranged on an end surface 3a of the drum shaft 3; the drum shaft 3, which is arranged at one end of the drum gear 2, is operable to reciprocate along an axial direction of the photoreceptor 1, wherein a force transmitting unit 3b and a guide column 3c are mounted at one end of the drum shaft 3 corresponding to the drum gear 2, and a force receiving unit 2a for matching the force transmitting unit 3b and a guide groove 2c for holding the guide column 3c are correspondingly mounted on the drum gear 2.

Preferably, the force transmitting unit 3b includes two arc-shaped bosses symmetrically provided on the outer peripheral surface of the end of the drum shaft 3 corresponding to the drum gear 2, and the arc-shaped bosses form two symmetrical notched grooves 3b1 on the outer peripheral surface of the drum shaft 3. The guide column 3c extends from the end of the drum shaft 3 corresponding to the drum gear 2. The force receiving unit includes two arc-shaped protrusions, which are symmetrically provided on the inner wall of a holding groove 2a1 for matching the symmetrical notched grooves 3b1, wherein the holding groove 2a1 for holding the drum shaft 3 is arranged at the end of the drum gear 2 corresponding to the drum shaft 3 The guide groove 2c, which is arranged at one end of the holding groove 2a1, extends into the drum gear 2. It should be understood that the invention may be including, but not limited to, the force transmitting unit 3b and the force receiving unit 2a which are respectively provided on the drum shaft 3 and the drum gear 2 described herein, and any well-known configurations that could meet the requirements of driving force transmission may be included within the scope of the present invention.

Additionally, according to the embodiment, an elastic member 6 is arranged between the drum shaft 3 and the drum gear 2. Preferably, the elastic member 6 is for example a compression spring, which is located in the guide groove 2c and sleeves the guide column 3c, wherein the compression spring has one end abutting a drum shaft positioning surface 3e formed at a joint of the guide column 3c and the drum shaft 3 and the other end abutting a drum gear positioning surface 2b formed at the other end of the drum gear 2 by the guide groove 2c. In the embodiment, as biased by the elastic member 6, it may be achieved that the drum shaft 3 is operable to reciprocate along a longitudinal direction L of the photoreceptor 1, as shown in FIG. 3 and FIG. 4.

In the embodiment, the photosensitive drum further comprises a drum shaft axial positioning element 7, which is lodged in an axial positioning groove 3d on a positioning column 3c of the drum shaft 3 so as to position the drum shaft 3 in the axial direction, wherein the positioning column 3c extends through the positioning groove 2c and projects from the other end of the drum gear 2, and the axial positioning groove 3d is arranged on the positioning column 3c extending from the other end of the drum gear 2. Preferably, according to the invention, the drum shaft axial positioning element 7 is a circlip.

In the embodiment, the projecting member 4 includes three vertical projecting members 4 extending along the longitudinal direction L of the photoreceptor 1 from the end surface 3a of the drum shaft 3, and these vertical projecting members 4 respectively correspond to three twisted surfaces 12 of a twisted triangular groove 11 on the driving head 20 of the imaging device. That is, the three vertical projecting members 4 are distributed uniformly along the rotation axis of the photoreceptor 1 over the end surface 3a of the drum shaft 3 so as to receive driving force from the imaging device through the coupling between the three vertical projecting members 4 and the three twisted surface 12 of the twisted triangular groove 11 on the driving head 20 of the imaging device. Preferably, a guide slanting surface 4a for enabling the photosensitive drum to be conveniently installed into the imaging device is arranged on the end surface of each projecting member 4 located on the end surface 3a of the drum shaft 3, and a guide surfaces 4b for enabling the photosensitive drum to be conveniently removed from the driving head 20 of the imaging device is arranged on a side wall of each projecting member 4 for coupling a corresponding twisted surface 12. It should be understood that the invention may be including, but not limited to, the number and shape of the projecting member 4 extending along the longitudinal direction L of the photoreceptor 1 from the end surface 3a of the drum shaft 3 described herein, and any well-known number or shape of the projecting member 4 that could meet the requirements of driving force transmission may be included within the scope of the present invention. For example, the projecting member 4 can merely include two or one vertical projecting member extending along the longitudinal direction L of the photoreceptor 1 from the end surface 3a of the drum shaft 3.

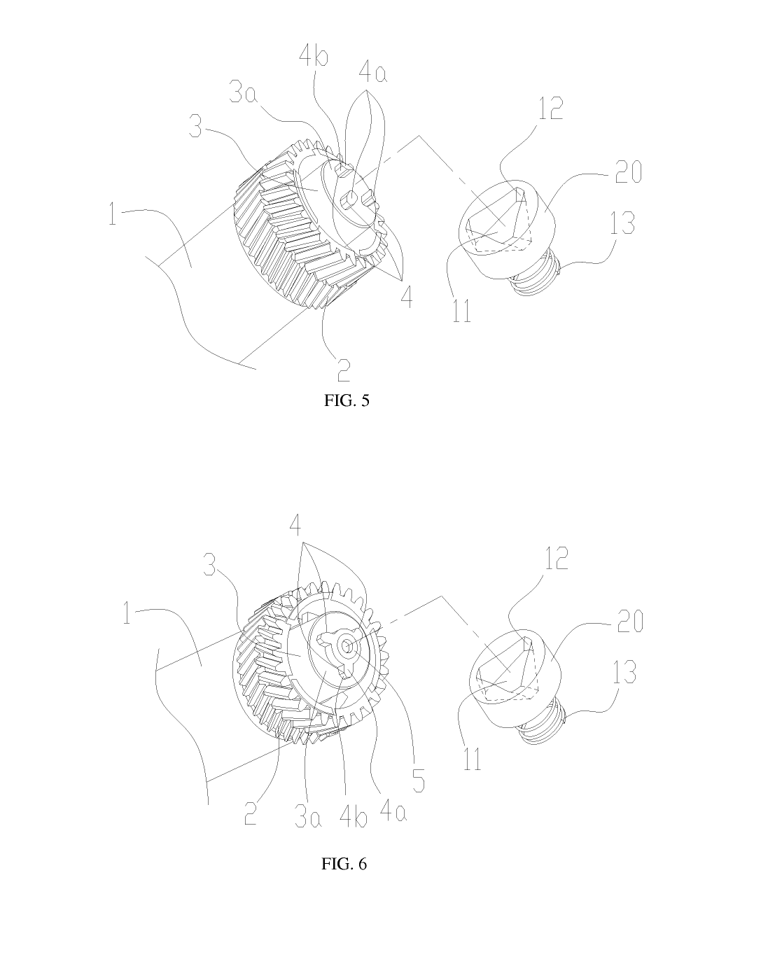

With reference to FIG. 2 to FIG. 5, the driving force transmitting process between the photosensitive drum and the imaging device according to the invention will be described in detail below. FIG. 5 is a schematic diagram showing the coupling between the driving head of the photosensitive drum and the driving head of the imaging device according to the first embodiment of the present invention. As shown in FIG. 2, when the process cartridge with the photosensitive drum according to the invention is installed in the imaging device, the interference fit between the guide surface 4a on the vertical projecting member 4 located at the end of the photosensitive drum and the inner wall of the imaging device produces an axial force, parallel to the rotation axial direction of the photoreceptor 1, so that the drum shaft 3 compresses the elastic member 6 and the elastic member 6 therefore retracts in the axial direction. When the process cartridge has been properly installed in the imaging device, which is then covered with a lid, an elastic member 13 at the end of the driving head 20 of the imaging device is compressed, so that the driving head 20 of the imaging device tends to project in the axial direction. Meanwhile, the vertical projecting member 4 at the end of the photosensitive drum can be abutting the driving head 20 of the imaging device under the restoring force applied by the elastic member 6. As the axial force applied by the elastic member 6 is larger than the axial force applied by the elastic member 13, the driving head 20 of the imaging device will be limited in the inner wall of the imaging device. When the imaging device is powered on, the vertical projecting member 4 at the end of the photosensitive drum will be inserted into the twisted groove 11 in the imaging device and be coupled with the twisted surface 12 thereof. In this way, the transmission of the driving force between them is accomplished. During the working process, one end of the vertical projecting member 4 of the photosensitive drum is subjected to a pressure from the elastic member 6, thus preventing the vertical projecting member 4 from being ejected from the driving head 20 of the imaging device. When the lid has been opened and the process cartridge has been taken out of the imaging device after the working process, an axial force will be produced between the guide surface 4b of the vertical projecting member 4 of the photosensitive drum and the driving head 20 of the imaging device to restrain the elastic deformation of the elastic member 6. The vertical projecting member 4 at the end of the photosensitive drum can therefore be conveniently removed from the driving head 20 of the imaging device.

### Embodiment 2

FIG. 6 is a schematic diagram showing the coupling between a driving head of a photosensitive drum and a driving head of a imaging device according to a second embodiment of the present invention. The photosensitive drum according to this embodiment is substantially similar to the one as described in the first embodiment. The difference is merely in that, in order to improve the strength in the transmission between the vertical projecting member 4 at the end of the photosensitive drum and the driving head 20 of the imaging device, an additional boss 5 is set between the three vertical projecting members 4 on the end surface 3a of the photosensitive drum shaft 3, said three vertical projecting members 4 being provided on a side wall of the boss 5. An effective and stable transmission between the photosensitive drum and the imaging device can therefore be achieved.

### Embodiment 3

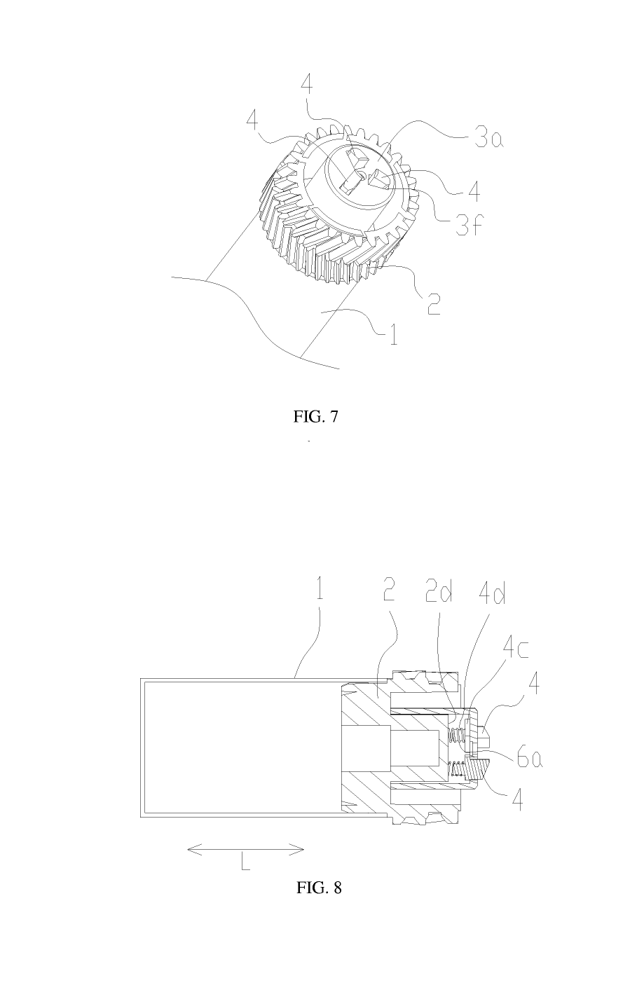

FIG. 7 is a perspective view of a driving head of a photosensitive drum according to a third embodiment of the present invention; FIG. 8 is a perspective view of a driving head at one end of a photoreceptor according to the third embodiment of the present invention. In the embodiment, as shown in FIG. 7 and FIG. 8, the photosensitive drum is different from the one as described in the first embodiment in that open grooves 3f respectively corresponding to the projecting members 4 are arranged on the end surface 3a of the photosensitive drum shaft 3, so that the projecting members 4 are provided in the open grooves 3f to be able to extend or retract along the longitudinal direction L of the photoreceptor 1. The drum shaft 3 is fixedly arranged on a boss at the end of the drum gear and forming a holding space between the end surface 2d of the boss and the drum shaft 3. Each open groove 3b arranged on the end surface 3a of the drum shaft 3 extends through the end surface 3a of the drum shaft 3 so as to connect the holding space with the exterior of the drum shaft 3. Each projecting member 4 located within the open grooves 3f has one end extending into the holding space and the other end projecting from the end surface 3a of the drum shaft 3. In the embodiment, the portion of the projecting member 4 that projects from the end surface 3a of the drum shaft 3 has a similar shape and configuration as the projecting member of the first embodiment. Preferably, the projecting member 4 located within the holding space is provided with a position limiter 4c projecting from a side wall of the projecting member 4 and abutting the circumference of the corresponding open groove 3f on the drum shaft 3. An elastic member 6a is arranged between the projecting member 4 and the end surface 2d of the boss of the drum gear 2. The elastic member 6a is for example a compression spring, which is located in the holding space and sleeves a guide column 4d of the projecting member 4. The compression spring has one end abutting the end surface 2d of the boss of the drum gear 2 and the other end abutting the position limiter 4c of the projecting member 4. In the embodiment, under the influence of the elastic member 6, it may be achieved that the projecting member 4 is operable to reciprocate along the longitudinal direction L of the photoreceptor 1.

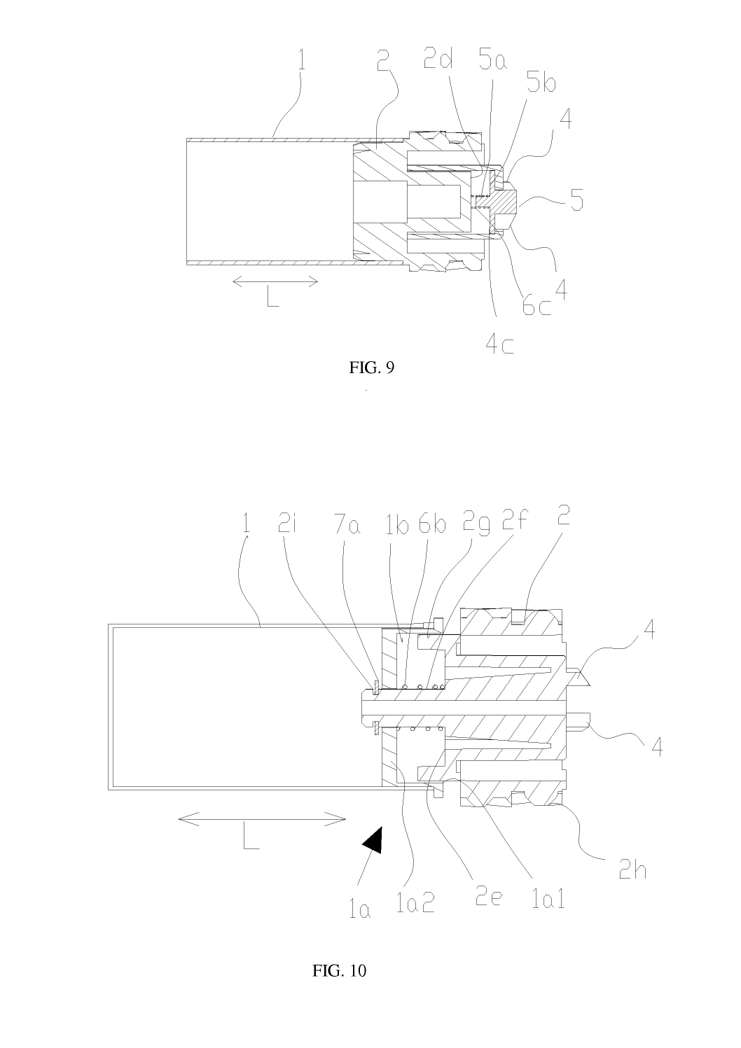

FIG. 9 is a section view of setting a projecting member at one end of the photosensitive drum according to the third embodiment of the present invention. As shown in FIG. 9, similar to the second embodiment, an additional boss 5 is set between the three vertical projecting members 4, said three vertical projecting members 4 being provided on a side wall of the boss 5, so that the boss 5, which is arranged in the open grooves 3f on the end surface 3a of the drum shaft 3, is operable to reciprocate together with the three vertical projecting members 4 extending along the longitudinal direction L of the photoreceptor 1 to achieve an effective and stable transmission between the photosensitive drum and the imaging device. In this case, the three vertical projecting members 4 and the boss 5 are formed in one-piece configuration, which is arranged within the open groove 3f and extends through the end surface 3a of the drum shaft 3, one end extending into the holding space and the other end projecting from the end surface 3a of the drum shaft 3. Thus, an elastic member 6c, which is arranged at one end of the one-piece configuration located in the holding space, is simply used to achieve such effect that the three vertical projecting members 4 and the boss 5 extend and retract together along the longitudinal direction L of the photoreceptor 1 together. Preferably, the elastic member 6c is a compression spring, which is located in the holding space and sleeves a guide column 5a projecting from the boss 5 towards the boss of the drum gear 2, wherein the compression spring has one end abutting the end surface 2d of the boss of the drum gear 2 and the other end abutting a positioning surface formed at a joint of the guide column 5a and the one-piece configuration.

### Embodiment 4

FIG. 10 is a section view of a driving head of a photosensitive drum according to a fourth embodiment of the present invention. In the embodiment, as shown in FIG. 10, the photosensitive drum is different from the one as described in the first embodiment in that the projecting member 4 is fixedly arranged on the end surface 3a of the drum shaft 3, which is fixedly arranged at the end of the drum gear 2, so that the drum gear 2, which is provided at one end of the photoreceptor 1, is operable to reciprocate along the axial direction of the photoreceptor 1. As a result, it can be achieved that the projecting members 4 extend or retract along the longitudinal direction L of the photoreceptor 1. A force transmitting unit 2g and a guide column 2f are mounted at the end of the drum gear 2 corresponding to the photoreceptor 1. A force receiving unit 1b for matching the force transmitting unit and a guide groove 1a for holding the guide column are correspondingly mounted on the photoreceptor 1. Preferably, the force transmitting unit 2g includes two arc-shaped protrusions, which are symmetrically provided on the end of the drum gear 2 corresponding to the photoreceptor 1 and extending from the outer peripheral edge of the end surface thereof towards the photoreceptor 1. The guild column 2f extends from the center of the end of the drum gear 2 corresponding to the photoreceptor 1. The guide groove 1a is arranged at the end of the photoreceptor 1 corresponding to the drum gear 2. The force receiving unit 1b includes two arc-shaped recesses, which are symmetrically arranged on the inner wall of the guide groove 1a and extending along the longitudinal direction of the photoreceptor 1 from the open end 1a1 of the guide groove 1a , corresponding to the drum gear 2, to the bottom surface 1a2 of the guide groove 1a for matching the arc-shaped protrusions 2g of the drum gear 2, wherein a gear portion 2h of the drum gear 2 is always located outside the guide groove 1a. It should be understood that the invention may be including, but not limited to, the force transmitting unit 2g and the force receiving unit 1b, which are respectively provided on the drum gear 2 and the photoreceptor 1 described herein, and any well-known configurations that could meet the requirements of driving force transmission may be included within the scope of the present invention.

Similarly, in the embodiment, an elastic member 6b is arranged between the drum gear 2 and the photoreceptor 1, wherein the elastic member is for example a compression spring. Preferably, the compression spring is located in the guide groove 1a and sleeves the guide column 2f. The compression spring has one end abutting a drum gear positioning surface 2e formed at a joint of the guide column 2f and the drum gear 2 and the other end abutting the bottom surface 1a2 of the guide groove 1a. In the embodiment, the photosensitive drum further comprises a drum gear axial positioning element 7a, which may be lodged in an axial positioning groove 2i on a positioning column 2f of the drum gear 2 so as to positioning the drum gear 2 in the axial direction. The positioning column 2f extends through the bottom surface 1a2 of the guide groove 1a and projects therefrom. The axial positioning groove 2i is arranged on the positioning column 2f extending from the bottom surface 1a2 of the guide groove 1a of the photoreceptor 1. Preferably, the drum gear axial positioning element 7a is a circlip. It should be understood that the number and shape of the projecting member 4 extending from the end surface 3a of the drum shaft 3 described herein may be similar to the first embodiment. Furthermore, similar to the second embodiment, an additional boss 5 is set between the three vertical projecting members 4 on the end surface 3a of the photosensitive drum shaft 3, said three vertical projecting members 4 being provided on a side wall of the boss 5, so that an effective and stable transmission between the photosensitive drum and the imaging device can be achieved.

### Embodiment 5

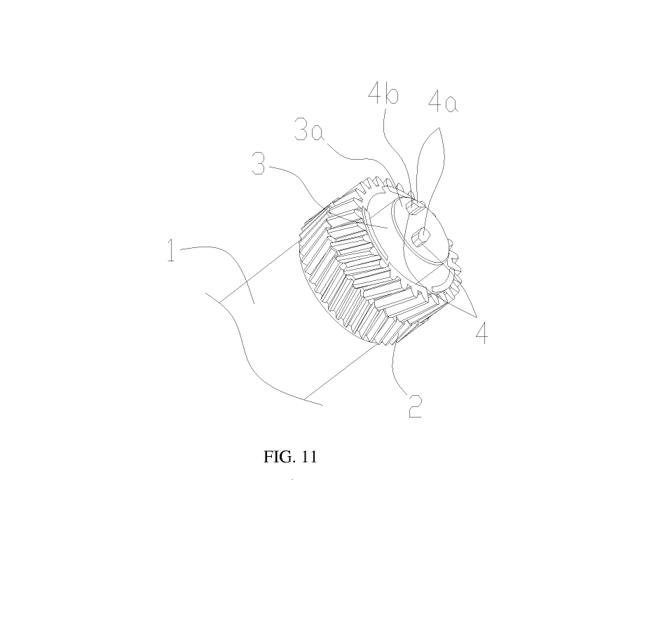

FIG. 11 is a perspective view of a driving head of a photosensitive drum according to a fifth embodiment of the present invention. As shown in FIG. 11, the photosensitive drum is substantially similar to the one as described in the first embodiment. The difference is merely in that the projecting member 4 extends along the longitudinal direction L of the photoreceptor 1 from the end surface 3a of the photosensitive drum shaft 3 include two vertical projecting members 4. These two vertical projecting members 4 respectively correspond to two twisted surfaces 12 of a twisted triangular groove 11 on the driving head 20 of the imaging device. Similarly, a guide slanting surface 4a for enabling the photosensitive drum to be conveniently installed into the imaging device and a guide surface 4b, coupling a corresponding twisted surface 12, for enabling the photosensitive drum to be conveniently removed from the driving head 20 of the imaging device after operation are respectively arranged on an end surface and a side wall of each vertical projecting member 4. Furthermore, similar to the second embodiment, an additional boss 5 is set between the two vertical projecting members 4 on the end surface 3a of the photosensitive drum shaft 3, said three vertical projecting members 4 being provided on a side wall of the boss 5, so that an effective and stable transmission between the photosensitive drum and the imaging device can be achieved. Similarly, such arrangement that two vertical projecting members 4 are provided on the end surface 3a of the photosensitive drum shaft 3 can also be adapted for the aforementioned third embodiment and fourth embodiment.

It is to be understood, however, that above-discussed embodiments are only preferred embodiments according to the present invention, but are not meant to limit the scope of the present invention. Although the present invention discloses the above preferred embodiments, any person skilled in the art can appropriately improve or modify the illustrated technical contents into equivalents with no extension of the scope of the technical solutions of the present invention. Any equivalents of the invention or modifications based on the spirit and principle of the invention are within the scope of the invention.

1. A photosensitive drum, comprising:
a cylindrical photoreceptor;
a drum gear located at one end of the photoreceptor;
a drum shaft extending along an axial direction of the photoreceptor from one end of the drum gear for rotatable supporting the photoreceptor; and
a projecting member extending along a longitudinal direction of the photoreceptor from an end surface of the drum shaft for coupling a twisted surface of a corresponding twisted triangular groove on a driving head of an imaging device,
wherein the photosensitive drum further comprises an elastic member, and the projecting member is provided at one end of the photoreceptor and is operable to reciprocate along the longitudinal direction of the photoreceptor with respect to the photoreceptor as biased by the elastic member.

2. A photosensitive drum according to claim 1, wherein an open groove corresponding to the projecting member is arranged on the end surface of the drum shaft, and the projecting member is provided within the open groove and is operable to reciprocate with respect to the photoreceptor along the longitudinal direction of the photoreceptor as biased by the elastic member.

3. A photosensitive drum according to claim 2, wherein the drum shaft is fixedly arranged on a boss on the end of the drum gear and forming a holding space between an end surface of the boss and the drum shaft; wherein the open groove arranged on the end surface of the drum shaft extends through the end surface of the drum shaft so as to connect the holding space with the exterior of the drum shaft; wherein the projecting member located within the open groove has one end extending into the holding space and the other end projecting from the end surface of the drum shaft; wherein the portion of the projecting member located within the holding space is provided with a position limiter, which projects from a side wall of the projecting member and abuts the circumference of the corresponding open groove on the drum shaft; and wherein the elastic member is located in the holding space and sleeves a guide column of the projecting member, and has one end abutting the end surface of the boss of the drum gear and the other end abutting the position limiter of the projecting member.

4. A photosensitive drum according to claim 1, wherein the projecting member is fixedly arranged on the end surface of the drum shaft, and the drum shaft, which is arranged at one end of the drum gear, is operable to reciprocate along the axial direction of the photoreceptor as biased by the elastic member.

5. A photosensitive drum according to claim 4, wherein a force transmitting unit and a guide column are mounted at the end of the drum shaft corresponding to the drum gear, and a force receiving unit for matching the force transmitting unit and a guide groove for holding the guide column are correspondingly mounted on the drum gear, wherein the elastic member, which sleeves the guide column, has one end abutting a drum shaft positioning surface formed at a joint of the guide column and the drum shaft and the other end abutting a drum gear positioning surface formed at the other end of the drum gear by the guide groove.

6. A photosensitive drum according to claim 5, wherein the photosensitive drum further comprises a drum shaft axial positioning element, which is lodged in an axial positioning groove on a positioning column of the drum shaft, wherein the positioning column runs through the positioning groove of the drum gear and extends from the other end of the drum gear, and wherein the axial positioning groove is arranged on the positioning column extending from the other end of the drum gear.

7. A photosensitive drum according to claim 1, wherein the projecting member is fixedly arranged on the end surface of the drum shaft, the drum shaft is fixedly arranged at the end of the drum gear, and the drum gear, which is arranged at one end of the photoreceptor, is operable to reciprocate along the axial direction of the photoreceptor as biased by the elastic member.

8. A photosensitive drum according to claim 7, wherein a force transmitting unit and a guide column are mounted at the end of the drum gear corresponding to the photoreceptor, and a force receiving unit for matching the force transmitting unit and a guide groove for holding the guide column are correspondingly mounted on the photoreceptor, wherein the elastic member, which is arranged in the guild groove and sleeves the guide column, has one end abutting a drum gear positioning surface formed at a joint of the guide column and the drum gear and the other end abutting the bottom surface of the guide groove.

9. A photosensitive drum according to claim 8, further comprising a drum gear axial positioning element, which is lodged in an axial positioning groove on a positioning column of the drum gear, wherein the positioning column extends through the bottom surface of the guide groove of the photoreceptor and projects therefrom, and the axial positioning groove is arranged on the positioning column extending from the bottom surface of the guide groove of the photoreceptor.

10. A photosensitive drum according to claim 1, wherein the elastic member is a compression spring.

11. A photosensitive drum according to claim 1, wherein the projecting member includes three vertical projecting members extending along the longitudinal direction of the photoreceptor from the end surface of the drum shaft.

12. A photosensitive drum according to claim 11, wherein a guide slanting surface is arranged on an end surface of each vertical projecting member located on the end surface of the drum shaft, and guide surfaces are arranged on a side wall of each projecting member for coupling the corresponding twisted surfaces.

13. A photosensitive drum according to claim 12, wherein a boss is arranged between the vertical projecting members on the end surface of the drum shaft, and the vertical projecting members are mounted on a side wall of the boss.

14. A process cartridge, comprising a photosensitive drum according to claim 1.
